(19) United States
(12) Patent Application Publication
(10) Pub. No.: US 2008/0185110 A1
(43) Pub. Date: Aug. 7, 2008

(54) Cord lock apparatus of window shade assembly

(75) Inventors: Ming Nien, Lugang Township (TW); Yu-Che Wen, Gueishan Township (TW); Chih-Yao Chang, Taichung City (TW); David Pon, Tustin, CA (US); Judkins Ren, Pittsburgh, PA (US)

Correspondence Address: RABIN & Berdo, PC, 1101 14TH STREET, NW, SUITE 500, WASHINGTON, DC, 20005, US

(73) Assignee: Nien Made Enterprise Co., Ltd., Taichuang City (TW)

(21) Appl. No.: 11/703,192

(22) Filed: Feb. 7, 2007

(51) Int. Cl. E06B 9/324

(52) U.S. Cl. 160/178.2; 160/84.01

(57) ABSTRACT

A cord lock apparatus of a window shade is provided, which comprises a base, a panel structure, and a cord gripping device. The base includes an adjustable portion allowing cords to pass through and a first-direction ascending opening is formed allowing the cords alternatively positioned. The panel structure having an insert plate and a second-direction ascending opening is provided allowing cords to pass through, when the cords are selectively positioned along the inclined surface, such panel structure is moved in a vertically upward or downward motion. The cord gripping device has an engaging block and a knurled roller, such engaging block is removably attached within the accommodation recess. The knurled roller is positioned near the top of the engaging block and a gap is formed therebetween, such that the knurled roller is frictionally locked with or released from the cords when the panel structure moves vertically downward or upward.

### BACKGROUND OF THE INVENTION

1. Field of Invention

The present invention relates to a cord lock apparatus for the control cords of a window shade or the like, and particularly to a cord lock apparatus which will be capable gripping a plurality of cords securely by altering the size of an engaging gap space.

2. Related Art

Quite frequently, a cord lock apparatus of a window shade or the like operated by a plurality of cords, such as a conventional blind or typically but not necessary a pleated shade, generally is mounted with a locking dog means. For example, U.S. Pat. No. 4,913,210 discloses a cord lock for window shades. FIG. 1 is a front perspective view of a cord lock in the prior art, and FIG. 2 is a sectional side view of FIG. 1. Referring to FIGS. 1 and 2, a base 12 is assembled on either one side of a generally U-shaped top rail 11 of a window shade 10, and at least two or a plurality of cords 13 pass through the base 12 from the lower portion and thence over an engagement mechanism 14. Then, the cords 13 are guided to an exit on top of the base 12, and from there enter the U-shaped top rail 11. Then, the cords 13 exit from the U-shaped top rail 11 to suspend a plurality of shade member 15 and a bottom rail 16. The engagement mechanism 14 uses two stopping members to relatively adjust the gap space therebetween, permitting the cords 13 to pass through. That is, the cords 13 are angularly tilted to a predetermined position, such that the engaging members are relatively forced to rotate to a selective angle, and then the cords are released. Moreover, the cords 13 still are further drawn to an alternative angle, the stopping members are subsequently reoriented by the cords 13 to move to another position so as to lockly engage the cords 13 in place, thereby locking the shade member 15 and the bottom rail 16 to a desirably raised or lowered position.

The method for the engagement mechanism 14 to lock the cords 13 in place is to generate a friction force by alternatively modifying the angle of the stopping members to angularly turn the cords 13 therebetween, and basically the shade member 15 are retained into a fixed position through a “point contact” friction in nature. Therefore, the overall weight of the shade member 15 is completely imposed on this contact point thereon the cords 13, hence the durability of such engaging cords are considerably less in strength. Moreover, though the engagement mechanism 14 can desirably achieve the locking and releasing effect interfering with the cords 13, the gap therebetween the stopping members of the engagement mechanism 14 cannot be adjusted accordingly, so one single specifications of such engagement mechanism 14 can only practically accommodate with limited cords diameters. When the weight or the thickness of the shade member changes substantially, the cords in alternative diameter are required accordingly and the entire engagement mechanism 14 has to be replaced altogether. And thus, the manufacturers must produce engagement mechanisms 14 in a variety of specifications to properly accommodate the varying cords diameters in usage and so that the object of modular design on parts of the window shade cannot be fully achieved. In addition, the consumers or window shade installers must carefully distinguish and select appropriate specifications of the engagement mechanism to prevent inaccuracies in assembly.

### SUMMARY OF THE INVENTION

Accordingly, a technical problem to be resolved by the present invention is to provide a cord lock apparatus of a window shade, which is capable of locking the cords at multiple contact points, so as to eliminate the worn out possibility of such engaging cords, and further to provide a cord lock apparatus of a window shade applicable for cords in varying diameters to pass through, without changing the original apparatus when the engaging cords are replaced into varying diameters. Another technical problem to be resolved by the present invention is to provide a window shade, which is effortlessly operated and capable of accommodating with varying cords diameters.

In order to resolve the aforementioned technical problems of the cord lock apparatus, the cord lock apparatus of the present invention comprises a base, a panel structure, and a cord gripping device. The base has an adjustable portion, a guide post, and a cord separating member positioned subsequently allowing cords to pass through. The adjustable portion has a first-direction ascending opening, a slot, and an accommodation recess, allowing the cords to be slided in a relative position along the oblique surface. The panel structure has an insert plate, and a second-direction ascending opening is disposed thereon. One end of the insert plate has an extension tongue extending frontwardly, and the other end is inserted into the slot. The cord gripping device has an engaging block and a knurled roller. Such engaging block is removably attached within the accommodation recess. The knurled roller then has a notched portion, an axial hole, and a groove allowing the extension tongue to be inserted therein. The knurled roller is pivotally disposed above the engaging block within the accommodation recess. Thus, two or a number of cords can enter from the first-direction ascending opening, pass through the second-direction ascending opening of the panel structure, and still further pass through the gap between the engaging block and the notched portion and thence pass along the guide post, and then, they are reoriented by the cord separating member and eventually enter into the top rail. When the cords pass therebetween the knurled roller and the engaging block, the panel structure subsequently moves in a vertical upward or downward movement, which will relatively affect the knurled roller rotating axially to the axial hole and thus lockly grip or release the cords therebetween.

If the control cords have to be rearranged in alternate diameter, replace the engaging block with appropriate thickness accordingly, whereby the gap between the engaging block and the notched portion is substantially changed and thus being applicable for cords with a greater or smaller diameter.

It is preferred that the present invention consists of a cord arrangement block along the cord passing path in the cord separating member of the base. The cord arrangement block has a cord receiving surface, such that the cords with one end bearing the overall weight of the shade member are made to be evenly distributed horizontally and from which subsequently enter into the top rail vertically.

It is further preferred that the present invention consists of a freely rotated sliding bush sleeved on the guide post permitting the cords to pass along thereon. Moreover, the guide post further comprises an end cap preventing the cords from dropping off from such guide post.

In order to resolve the aforementioned technical problems of a window shade, the present invention applies the knurled roller-type cord lock apparatus, so as to accommodate the utilization of cords having different diameters.

The advantage of the present invention lies in that, both of the knurled roller and the engaging block for lockly gripping the cords passing through are removably attached structures so as to ease the cords installation. Simply replace the engaging block size, the cords in alternate diameters can be lockly gripped therein. Also, the modular components provide the flexibility and variety in use and the capability for mass production required in the commercial environment. Moreover, when adjusting the cords, the friction force imposed against the guide post where the cords are passed over can be substantially minimised through the utilization of the sliding bush structure, so the user can apply considerably less force to adjust the shade member, and further enhance the operative performance of the control cords.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limited to the present invention, and wherein:

FIG. 1 is an overall front view of a cord lock for window shades in the prior art;

FIG. 2 is a cross sectional view of FIG. 1;

FIG. 3 is an exploded view of a cord lock apparatus in accordance with the present invention;

FIG. 4 is a schematic view illustrating a lock position and a release position of the control cords of a window shade in accordance with the present invention;

FIG. 5 is a schematic top plan view of the cord lock apparatus in accordance with the present invention;

FIG. 6A is a section taken along line I-I of FIG. 5, with the control cords shown in the “release” position in accordance with the present invention;

FIG. 6B is an enlarged fragmentary section shown in FIG. 6A;

FIG. 7A is a section taken along line I-I of FIG. 5, with the control cords shown in the “lock” position in accordance with the present invention;

FIG. 7B is an enlarged fragmentary section shown in FIG. 7A; and

FIGS. 8A and 8B are enlarged schematic views illustrating the engaging cords in varying diameters in accordance with the present invention.

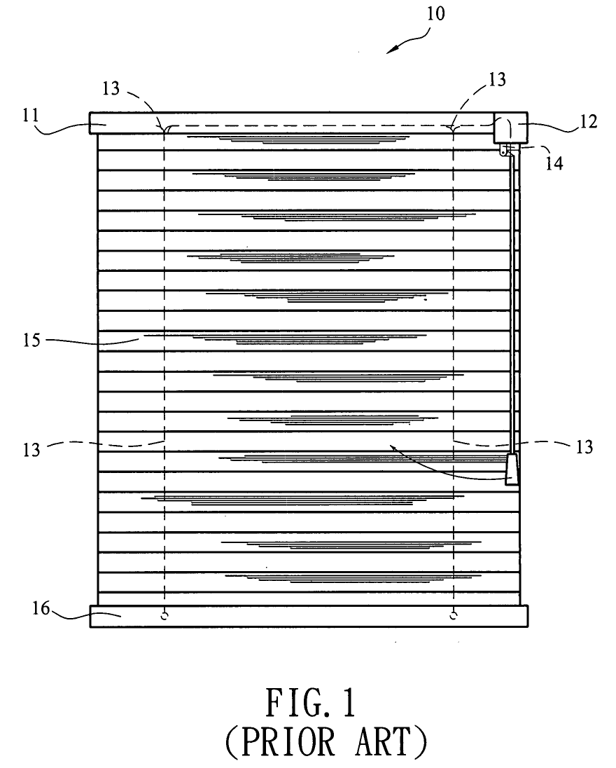

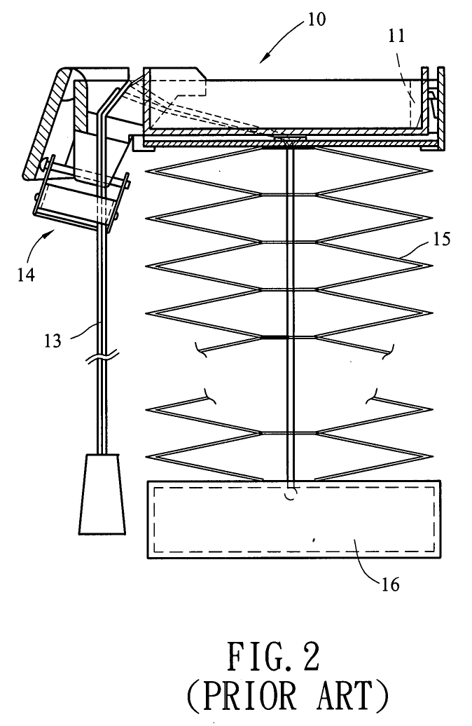

### DETAILED DESCRIPTION OF THE INVENTION

The present invention is illustrated below more specifically with reference to the accompanying drawings and the embodiments.

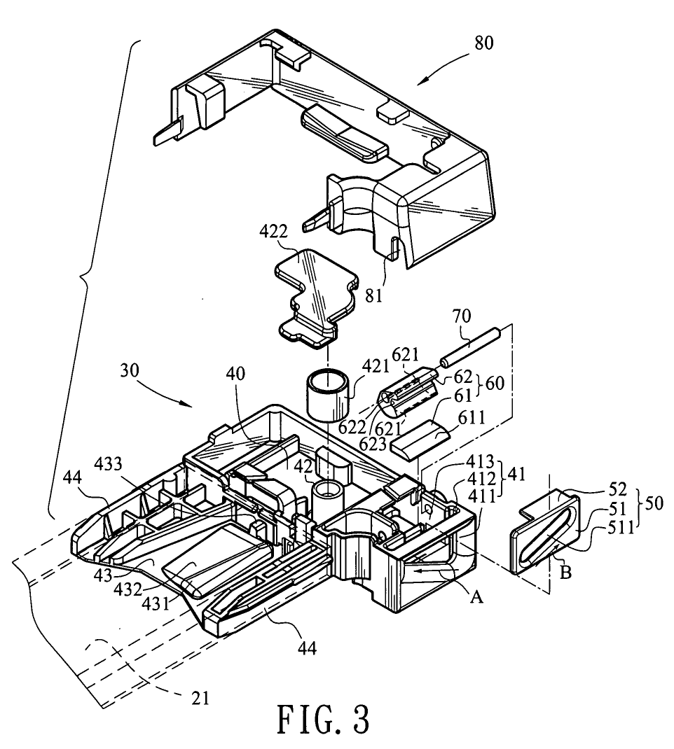

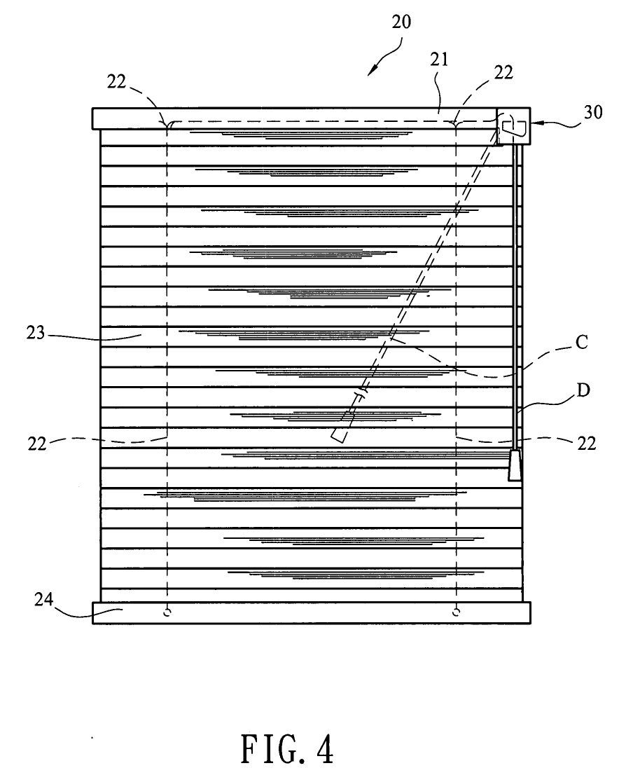

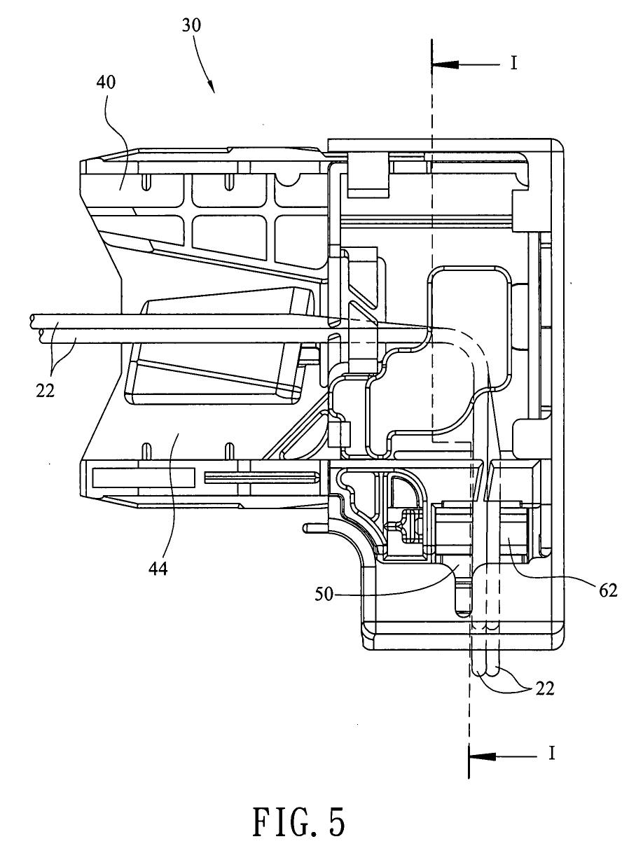

FIG. 3 is an exploded view of a cord lock apparatus in accordance with the present invention, FIG. 4 is a perspective front view of a window shade or the like with the cords shown in the engaged and unlocked (dotted lines) positions in accordance with the present invention, and FIG. 5 is a schematic top plan view of the cord lock apparatus in accordance with the present invention. Such cord lock apparatus 30 includes a base 40, a panel structure 50 and a cord gripping device 60 are assembled thereon. The base 40 has an adjustable portion 41, a guide post 42, and a cord separating member 43 positioned relatively to such guide post 42 providing a turning angle to the adjustable portion 41, whereby the first-direction ascending opening 411 is integrally formed extending from the outermost portion of the base 40 facing in the same orientation as of first direction A and a slot 412 disposed perpendicularly to the cords entering entry with an accommodation recess 413 formed therein. The panel structure 50 includes an insert plate 51 having a second-direction ascending opening 511 as of the second direction B facing in an opposite direction to the first direction A (such opening is given as of oval-shaped aperture in this embodiment, however, numerous modifications may be made to the shape according to the present invention as long as a pair of inclined apertures oriented in the opposite orientation to one another as of described hereinafter the contact surface I and H). One end of the insert plate 51 extending outwardly from the upper margin to form an extension tongue and the other end is removably inserted into the slot 412. The cord gripping device 60 includes an engaging block 61 and a knurled roller 62, the engaging block 61 is disposed within the accommodation recess 413 having an arch-like front surface 611 facing toward the panel structure so as to evenly and uniformly dispose the receiving cords 22 thereon, assuring the subsequent gripping effect in full. The knurled roller 62 has a notched portion 621, an axial hole 622 passing longitudinally through the knurled roller 62, and a groove 623 allowing the extension tongued 52 to be inserted therein. Such knurled roller 62 is pivotally positioned above the engaging block 61 within the accommodation recess 413 by a shaft 70 passing through the axial hole 622, whereby the knurled roller 62 rotates axially with respect to the axial hole 622 under the relative effect of such extension tongue 52 being inserted into the groove 623 when the panel structure 50 moves vertically upward or downward within the slot 412.

The cord lock apparatus described above allowing the base 40 to be attachably inserted into the longitudinal opening of the top rail 21. In order to bear the overall weight contributed by the cords 22 and the shade member 23 and the external forces operatively applied by the user when tilting the cords 22, the cord separating member 43 of the base 40 further includes an embedded body 44 so as to lockly engage against the interior of the top rail 21. At least two or a plurality of cords 22 enter into the adjustable portion 41 of the cord lock apparatus 30, then pass through the first-direction ascending opening 411, the slot 412, and the second-direction ascending opening 511 of the panel structure 50, and further pass therebetween through the engaging block 61 and the knurled roller 62. Then, the cords 22 are redirected into another orientation through the guide post 42, and exit the base 40 from the cord separating member 43 and thence eventually enter into the top rail 21, whereby the cords 22 will exit from the top rail 21 to engage with a bottom rail 24 that suspends a plurality of shade member 23.

The guide post 42 is designed as of a cords guiding device, which to allow the user to operatively adjust the cords in the front of the window shade 20 and such action is engaged in a parallel plane with respect to the shade member 23. When the user tilts the cords 22 to the position C, the cords 22 can be relatively adjusted so as to lower or raise the position of the shade member 23 and the bottom rail 24 altogether. When the user releases the cords 22 or relocate the cords to position D, the position of the window shade 23 and the top rail 21 are fixed in place. (Such operation will be described below in details).

In the embodiment of the cord lock apparatus 30 mentioned above, the cord separating member 43 can further include a cord arrangement block 431 along the path of the cords 22 therein. The cord arrangement block 431 has an oblique cords receiving surface 432 for carrying the cords 22 thereon, which to bear the overall weight of the shade member 23, such that the cords 22 will remain separated and they will be prevented from clustering and overlapping one another, assuring that the cords will enter the top rail 21 uniformly and evenly.

In the embodiment of the cord lock apparatus 30 mentioned above, a stopper 433 is further disposed at a front edge of a cord entry end of the cord arrangement block 431 that is, near the sidewall of the cord arrangement block adjacent to the guide post to engage against the interior of the top rail 21 and provide a frictionally interacting effect to one another so as to prevent the cords 22 drop off from the oblique cords receiving surface 432 when such cords are angularly operated.

In the embodiment of the cord lock apparatus 30, a freely-rotated sliding bush 421 is further included for being sleeved on the guide post 42, such that the cords 22 are passed along more smoothly to achieve an effortless operation and reduce the interacting friction when adjusting the cords 22. One end of the guide post 42 is further covered by an end cap 422 so as to limit and prevent the passing cords 22 leaving from the guide post 42 when repeatedly adjusting the shade member 23 to a desired position.

Moreover, the cord lock apparatus 30 can further include a cover 80 assembled on the base 40. The cover 80 provides a moving space for the cords 22 outside the first-direction ascending opening 411 of the adjustable portion 41. A cave aperture 81 is perpendicularly disposed to the end of the first-direction ascending opening 411, allowing the cords 22 to offset an angle in this direction during operation.

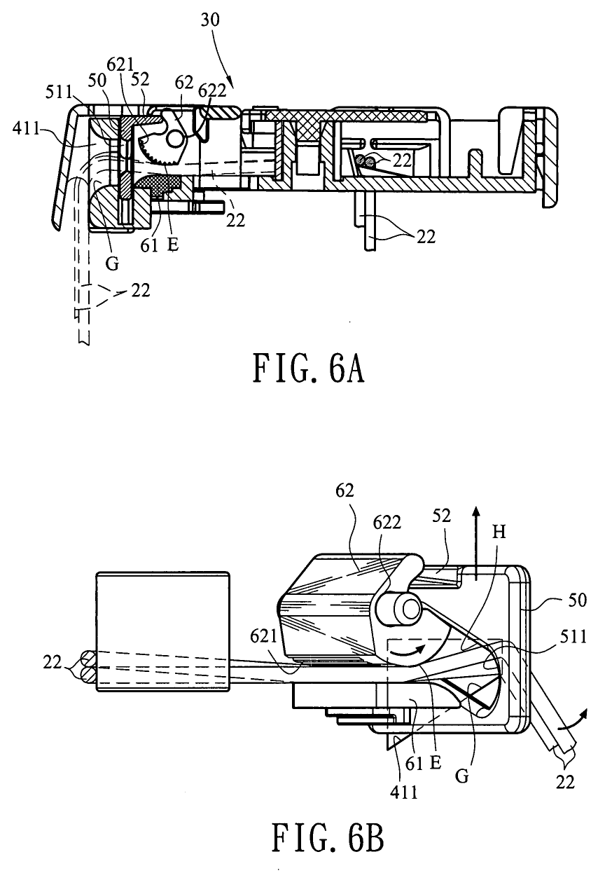

FIG. 6A is a schematic sectional view taken along I-I of FIG. 5, with the cords shown in the “release” position in accordance with the present invention, and FIG. 6B is an enlarged fragmentary section shown in FIG. 6A. When the cords 22 are drawn to the adjusting position C (as shown in FIG. 4), after contacting a contact surface G of the first-direction ascending opening 411, the cords 22 slide up towards the first direction A (as shown in FIG. 3), and meanwhile, the cords 22 also contact a contact surface H at an upper portion of the second-direction ascending opening 511 to drive the panel structure 50 to move upward. When the panel structure 50 moves upward, the extension tongue 52 interacts with the knurled roller 62 and so that the knurled roller 62 rotates to a release position E and subsequently release the cords of which originally securely locked in place with the engaging block 61 therebetween (as the radius between the axial hole 622 and the notched portion 621 interfering with the cords 22 is substantially reduced). Therefore, the cords 22 can be freely drawn and released at the adjusting position C.

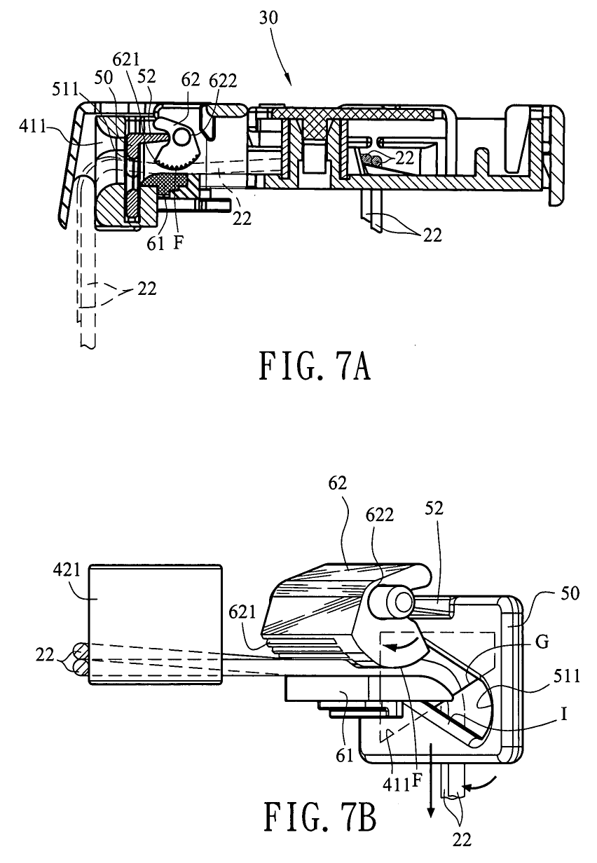

FIG. 7A is a section taken along line I-I of FIG. 5, with the cords shown in the “lock” position in accordance with the present invention, and FIG. 7B is an enlarged fragmentary section shown in FIG. 7A. When the cords 22 are drawn to the adjusting position D (as shown in FIG. 4), the cords 22 slide to the second direction B (as shown in FIG. 3), and then the force pulling the cords 22 is released (or the pulling force applied on the cords 22 is directly released at the adjusting position C). Such pulling force acting on the cords 22 is generated from the overall weight of the shade member 23 and the bottom rail 24 (as shown in FIG. 4), when the cords 22 pass along the guide post 42 or the sliding bush 421, the pulling force is subsequently transmitted to a contact surface I at a lower portion of the second-direction ascending opening 511. As the inclined contact surface I generates a force to effect the panel structure 50 to move vertically downward, the extension tongue 52 of the panel structure 50 simultaneously moves vertically downward and rotates the engaging block 61 to a locking position F so as to securely lock the cords 22 thereon the engaging block 61 (as the radius between the axial hole 622 and the notched portion 621 interfering with the cords 22 is substantially increased). As a result, the cords 22 are secured at a locking state, and cannot be drawn or released freely.

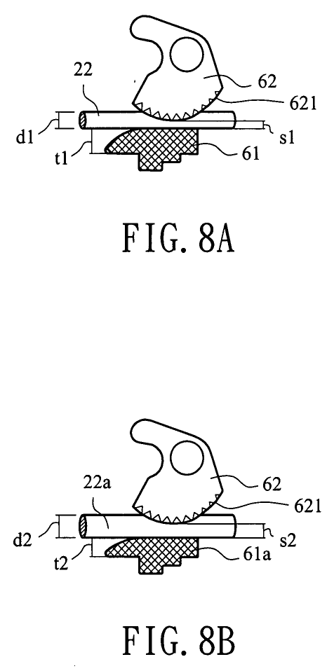

FIGS. 8A and 8B are enlarged schematic views illustrating the engaging cords in varying diameters in accordance with the present invention. A gap s1 is formed between the notched portion 621 and the removably engaging block 61 in thickness t1, allowing the cords to pass through and being applicable for locking the cords 22 having the diameter d1 in place. When the engaging block 61a having the less thickness in t2 is rearranged, a substantially increased gap s2 is formed therebetween the engaging block 61a and the notched portion 62 comparatively to the original gap s1 so as to allow the cords 22a with a relatively increasing diameter d2 in relation to the original diameter d1 of the cords 22 to passing through.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cord lock apparatus, housing in a top rail of a window shade or the like and into which allowing a plurality of cords to pass through and from which guiding said cords into said top rail of said window shade and then exit therefrom one end of said top rail, said apparatus comprising:
a base, having an adjustable portion, a guide post, and a cord separating member, such guide post is positioned thereon for said cords to laterally pass along, wherein said cord separating member is relatively positioned to said guide post and further provided an angle to said adjustable portion therebetween so as to define a passage for said cords to pass along and enter into said top rail, and said adjustable portion has a first-direction ascending opening and an accommodation recess respectively;
a panel structure, disposed on said adjustable portion of said base to move in an upward or downward vertical motion, and an insert plate wherein a second-direction ascending opening oriented in an opposite direction from said first-direction ascending opening is disposed thereon allowing said cords to pass through, and an extension tongue is provided extending frontwardly from the upper margin of said insert plate; and
a cord gripping device including an engaging block and a knurled roller, such engaging block having an oblique surface at one side and is attached to said accommodation recess, said knurled roller including a notched portion and an axial hole of which is positioned near the top of said engaging block within said accommodation recess by a shaft passing through such axial hole, and a gap is provided therebetween said knurled roller and said engaging block allowing said cords to pass through;
wherein said panel structure is alternatively adapted to move in a vertically upward or downward motion under the operatively effect of said cords, said extension tongue effects said knurled roller orienting to an engaged position when said panel structure is relatively moved in a downward motion wherein the gap between said knurled roller and said engaging block is reduced so as to grip said cords in place, said extension tongue effects said knurled roller reorienting to a unlock position when said panel structure is relatively moved in a upward motion wherein the gap between said knurled roller and said engaging block is increased permitting the release action of said cords.

2. The apparatus of claim 1 wherein said cord separating member further includes a cord arrangement block disposed on a cord passing path of said cords of which an oblique surface is shaped along one side of such cord arrangement block horizontally receiving said cords thereon.

3. The apparatus of claim 2 wherein a stopper is provided near the top of said cord arrangement block adjacent to said guide post so as to be securely inserted into the interior of said top rail.

4. The apparatus of claim 1 further including a rotatable moving bush sleeved on said guide post accommodating said cords to pass along.

5. The apparatus of claim 1 wherein said guide post further comprises an end cap.

6. The apparatus of claim 1 wherein said cord separating member of said base further comprises an embedded body as to be securely inserted into the inner end of said top rail.

7. The apparatus of claim 1 comprising an alternate engaging block in varying thickness to accommodate the replacement of said engaging block.

8. A window shade or the like comprising:
a cord lock apparatus including a base, a panel structure, and a cord gripping device wherein said base further includes a cord separating member, a guide post, and an adjustable member, such cord separating member is positioned relatively to said guide post and further defined an angle therebetween to said adjustable member including a first-direction ascending opening and an accommodation recess therein; said panel structure has an insert plate wherein a second-direction ascending opening is disposed thereon, and an extension tongue extending frontwardly from the upper margin of said panel structure, said cord griping device further comprises an engaging block and a knurled roller, such engaging block is removably attached within said accommodation recess, said knurled roller further provides a notched portion and an axial hole of which is pivotally positioned within said accommodation recess by a shaft passing through said axial hole and a gap is formed therebetween said knurled roller and said engaging block, whereby said knurled roller is frictionally engaged either to achieve an unlock position or a lock position when said panel structure is moving relatively in a vertically upwardly or downwardly motion;
a top rail allowing said cord lock securely housed therein;
at least a window shade member is suspended beneath said top rail;
a bottom rail disposed beneath said window shade member; and
a plurality of cords consecutively passing through said cord lock apparatus, said top rail, said window shade member, and said bottom rail.
